(19) United States
(12) Patent Application Publication
(10) Pub. No.: US 2026/0257452 A1
(43) Pub. Date: Sep. 3, 2026

(54) A METHOD FOR PRODUCING A BARRIER SUBSTRATE, AND A BARRIER SUBSTRATE

(71) Applicant: Stora Enso OYJ, Helsinki (FI)

(72) Inventors: Otto Nylén, Helsinki (FI); Kaj Backfolk, Lappeenranta (FI); Anni Karppinen, Espoo (FI)

(73) Assignee: Stora Enso OYJ, Helsinki (FI)

(21) Appl. No.: 18/872,951

(22) PCT Filed: Jun. 29, 2023
(86) PCT No.: PCT/IB2023/056762

§ 371 Date: Dec. 9, 2024

(30) Foreign Application Priority Data
Jul. 8, 2022 (SE) 2230230-1

(51) Int. Cl. B32B 5/18; B32B 23/06; B32B 29/00; B32B 37/10

(52) U.S. Cl. CPC B32B 5/18; B32B 23/06; B32B 29/00; B32B 37/1054; B32B 2255/10; B32B 2255/205; B32B 2266/0292; B32B 2274/00; B32B 2307/72; B32B 2317/18; B32B 2553/00

(57) ABSTRACT

The present invention relates to a method for producing a barrier substrate comprising a microfibrillated cellulose (MFC) film and a polymer film. The method comprises providing a suspension comprising 50-100 weight-% MFC based on total dry weight and having a dry content of 1-40 weight-%. A wet MFC film is formed of the suspension by casting on a non-porous support and the wet MFC film positioned on the support is dewatered and/or dried to a dry MFC film having a moisture content of 20 weight-% or less. A polymer film is applied on the dry MFC film positioned on the support to form an intermediate substrate, which is pressed in at least one nip to form the barrier substrate. The invention relates also to a barrier substrate obtained by the method, a laminate comprising the barrier substrate and a paper or paperboard substrate, and a packaging material comprising the barrier substrate or the laminate.

### TECHNICAL FIELD

The present disclosure relates to a method for producing a barrier substrate comprising a barrier film and a polymer film, wherein the barrier film is a microfibrillated cellulose (MFC) film. In addition, the present disclosure relates to a barrier substrate obtained by the method, a laminate comprising a paper or paperboard substrate and the barrier substrate, a packaging material comprising the barrier substrate or the laminate and use of the barrier substrate or the laminate in a packaging material.

### BACKGROUND

Oxygen, grease, water vapor and/or aroma barrier properties are required in many uses of paper and paperboard packaging. However, paper and paperboard substrates do not have these properties inherently. Most commonly barrier characteristics of paper and paperboard substrates are created by adding one or more barrier coatings and/or laminated barrier layers which are based on plastics or other non-renewable materials. The disadvantage with these coatings and barrier layers is their non-renewable raw material basis that can increase the carbon dioxide footprint of the material as well as make the otherwise biodegradable paper or paperboard non-biodegradable and in some cases non-recyclable. Furthermore, in order to improve a barrier comprising barrier coatings and/or laminated barrier layers based on plastics or other non-renewable materials, it is usually needed to increase the amount of used polymer and/or various polymer layers. Hence, the possibility to disintegrate and recycle fiber fraction(s) of paper or paperboard substrates provided with such improved barriers becomes then even more difficult.

More recently, microfibrillated cellulose (MFC) films have been developed, in which cellulosic fibrils, provided by fibrillation of cellulose fibers, have been suspended, e.g., in water and thereafter re-organized and re-bonded together to form a dense film with barrier properties, such as oxygen, aroma and grease barrier properties. MFC films are recyclable and biodegradable as well as based on renewable raw material.

One approach to produce an MFC film is to use a film casting method, i.e., forming a film by casting an MFC suspension on a non-porous support such as a plastic or metal support and then dewatering and/or drying the film. Casting methods have been shown to produce MFC films with very smooth surfaces with good barrier properties, such as oxygen barrier properties and/or water vapor barrier properties.

Another approach to produce an MFC film is to use a wet laid technique, i.e., to apply a layer of an MFC suspension on a dewatering wire or membrane and dewater it by vacuum, gravitation, capillary dewatering, press dewatering or a combination of these on the wire or membrane followed by drying or liquid evaporation. However, one disadvantage with this approach is that film additives that are either dissolved or emulsified in the aqueous phase of the MFC suspension are removed from the MFC layer to a large extent during the dewatering. Retention and/or flocculation agents may thus be needed to counteract removal of film additives. However, retention and/or flocculation agents usually have a negative impact on barrier properties and do not guarantee complete retention. Also, this approach has limitations for the used MFC type, as very fine MFC cannot be used as it can also pass or penetrate through the wire or clog the wire or membrane. In addition, other very small dissolved or solid particles dispersed in aqueous phase of MFC suspension, such as mineral nanofillers, have tendency to pass and penetrate through the wire or membrane in dewatering steps.

It is known to include MFC films in barrier substrates and laminates comprising one or more further layers or films. For example, barrier substrates comprising an MFC film and laminates comprising an MFC film and a paper or paperboard substrate have been disclosed for use in e.g., packaging materials or applications, such as liquid or food packaging materials. Such barrier substrates and laminates can be manufactured almost entirely from biobased materials, and preferably from cellulose-based materials, thereby facilitating re-pulping and recycling of used packaging materials comprising the barrier substrate or laminate and enabling an aluminum foil free laminate structure for e.g., aseptic packaging. However, sometimes one or two outermost polymer layers or films are comprised in such barrier substrates and laminates. The outermost polymer layers or films preferably provide liquid barrier properties and mechanical protection for the surface of the barrier substrate or laminate. The outermost polymer layers or films are preferably also heat-sealable. Sometimes the outermost polymer layers are also used for decorative purposes, such as for printing or protection of printing.

Commonly, free-standing MFC films, such as free-standing MFC films produced by a casting method or a wet-laid method, have limited strength properties, such as tear, burst and tensile strength. This may lead to difficulties in lamination or coating processes since the MFC films need to withstand rather high forces applied during the lamination or coating processes. Thus, the limited strength properties may lead to runnability problems and web breaks or defects in such MFC films when used in lamination or coating processes.

Lamination of an MFC film with polymer films and/or other substrates or layers such as paper or paperboard substrates, may be performed using wet glue or an extruded tie layer. If wet glue is utilized in the lamination, it is important that the MFC film has sufficient strength, in particular wet strength, to withstand the wet glue. Also, when using an MFC film in extrusion lamination or extrusion coating, it is important that the MFC film has sufficient tear and tensile strength (including stretch at break) to withstand the forces applied in the lamination or extrusion process. The tear and tensile strength of the MFC film may be improved by adding a reinforcement agent to the MFC film and/or by increasing the grammage of the MFC film. However, addition of a reinforcement agent and/or increase of the grammage may reduce the production efficiency.

Thus, there is still room for improvements of methods for producing barrier substrates comprising a barrier film and a polymer film, wherein the barrier film is an MFC film, and laminates comprising such a barrier substrate.

### DESCRIPTION OF THE INVENTION

It is an object of the present invention to provide an improved method for producing a barrier substrate comprising a barrier film and a polymer film, wherein the barrier film is an MFC film, which method reduces the difficulties with limited strength properties of MFC films in lamination or coating processes and which method eliminates or alleviates at least some of the disadvantages of the prior art methods.

The above-mentioned object, as well as other objects as will be realized by the skilled person in the light of the present disclosure, is achieved by the various aspects of the present disclosure.

The invention is defined by the appended independent claims. Embodiments are set forth in the appended dependent claims and in the following description.

According to a first aspect illustrated herein, there is provided a method for producing a barrier substrate comprising a microfibrillated cellulose (MFC) film and a polymer film, wherein the method comprises the steps of:
providing an MFC suspension comprising between 50 weight-% to 100 weight-% MFC based on total dry weight, wherein said MFC suspension has a dry content of 1-40 weight-%;
forming a wet MFC film of said MFC suspension by casting on a non-porous support;
dewatering and/or drying said wet MFC film positioned on said non-porous support to a dry MFC film having a moisture content of 20 weight-% or less;
applying a first polymer film on a first side of said dry MFC film positioned on said non-porous support to form an intermediate substrate,
pressing said intermediate substrate positioned on said non-porous support in at least one nip to form said barrier substrate, and
separating said barrier substrate from said non-porous support.

Thus, the method of the first aspect provides a barrier substrate comprising an MFC film, which is a barrier film, and a polymer film.

With the method according to the first aspect, a polymer film is applied to an MFC film in connection with, or during, the production of the MFC film, i.e., a polymer film is applied to the MFC film when the MFC film is still positioned on the non-porous support used for forming the MFC film by a casting technique. Thus, a barrier substrate comprising an MFC film and a polymer film is formed on the non-porous support and the barrier substrate is removed from the non-porous support after formation to form a free-standing barrier substrate.

By providing the MFC film with the polymer film already when the MFC film is still positioned on the non-porous support, the MFC film is supported by the non-porous support during the application procedure of the polymer film. Thereby, difficulties with limited strength properties of the MFC film in processes for application of the polymer film are counteracted.

Also, by providing the MFC film with a polymer film already in connection with the production of the MFC film, the MFC film is included in a barrier substrate already in connection with the production of the MFC film and is thus strengthened by the polymer film in the free-standing barrier substrate. Thus, when using the free-standing barrier substrate in a subsequent lamination or coating process, the MFC film is supported/reinforced by the polymer film, whereby the limited strength properties of the MFC film are counteracted.

The term film as used herein refers generally to a thin continuous sheet formed material, such as a thin substrate with good gas, aroma or grease or oil barrier properties, e.g., oxygen barrier properties and/or water vapor barrier properties. Depending on the composition of the MFC suspension from which it is formed, the film can also be considered as a thin paper (e.g., nanopaper or micropaper) or even as a membrane.

As mentioned above, the method of the first aspect comprises a step of providing an MFC suspension comprising between 50 weight-% to 100 weight-% MFC based on total dry weight of the MFC suspension. The MFC suspension has a dry content of 1-40 weight-%. The MFC suspension comprises a suspension medium in which a mixture of cellulose-based material and optionally additives are suspended. Preferably, the MFC suspension is an aqueous suspension comprising a water-suspended mixture of cellulose-based material and optionally additives.

Microfibrillated cellulose (MFC) shall in the context of the patent application mean a cellulose particle, fiber or fibril having a width or diameter of from 20 nm to 1000 nm.

Various methods exist to make MFC, such as single or multiple pass refining, pre-hydrolysis followed by refining or high shear disintegration or liberation of fibrils. One or several pre-treatment steps is usually required in order to make MFC manufacturing both energy efficient and sustainable. The cellulose fibers of the pulp used when producing MFC may thus be native or pre-treated enzymatically or chemically, for example to reduce the quantity of hemicellulose or lignin. The cellulose fibers may be chemically modified before fibrillation, wherein the cellulose molecules contain functional groups other (or more) than found in the original cellulose. Such groups include, among others, carboxymethyl (CM), aldehyde and/or carboxyl groups (cellulose obtained by oxidation, for example 2,2′,6,6′-tetramethylpiperidin-N-oxyl (TEMPO)) or quaternary ammonium (cationic cellulose). After being modified in one of the above-described methods, it is easier to disintegrate the fibers into MFC.

MFC can be produced from wood cellulose fibers, both from hardwood and/or softwood fibers. It can also be made from microbial sources, agricultural fibers such as wheat straw pulp, bamboo, bagasse, or other non-wood fiber sources. It can be made from pulp, including pulp from virgin fiber, e.g., mechanical, chemical and/or thermomechanical pulps. It can also be made from broke or recycled paper.

As mentioned above, the MFC suspension used in the method of the first aspect comprises between 50 weight-% to 100 weight-% of MFC based on total dry weight. In some embodiments, the MFC suspension comprises between 60 weight-% to 100 weight-%, preferably between 70 weight-% to 100 weight-%, more preferably between 80 weight-% to 100 weight-% of MFC based on total dry weight. The MFC film of the barrier substrate produced by the method of the first aspect may comprise between 50 weight-% to 100 weight-%, such as between 60 weight-% to 100 weight-%, preferably between 70 weight-% to 100 weight-%, more preferably between 80 weight-% to 100 weight-% of MFC based on total dry weight, wherein this relates to the amount of MFC in the film per se.

The MFC of the MFC suspension may comprise one or more fractions of MFC. In some embodiments, the MFC of the MFC suspension comprises one fraction of MFC of a fine grade. In some embodiments, the MFC of the MFC suspension comprises two or more fractions of MFC of different fine grades. In some embodiments, the MFC of the MFC suspension comprises one fraction of a fine grade and one fraction of a coarse grade, wherein the coarse grade for example may be an additive. Coarse MFC in this case has typically a Schopper-Riegler value of 80-100 SR°, such as 80-99 SR° or 90-99 SR° or 95-99 SR°, whereas fine MFC is fibrillated to a Schopper-Riegler value above the measurement range (theoretical value about or above 100 SR°) as determined by standard ISO 5267-1. In some embodiments, the fine grade MFC is chemically derivatized, such as carboxymethylated MFC.

The MFC suspension may in addition to MFC comprise any conventional paper making additives or chemicals such as film-forming agents, dispersants, fillers, pigments, wet strength chemicals, cross-linkers, plasticizers, softeners, humectants, adhesion primers, wetting agents, biocides, colorants, de-foaming chemicals, hydrophobizing chemicals such as alkyl ketene dimer (AKD), alkenyl succinic anhydride (ASA), waxes, rosin resins, mineral additives (fillers) such as bentonite, kaolin, talcum, mica, montmorillonite, organoclays, graphene and graphene oxide, stearate, starch, silica, precipitated calcium carbonate, cationic polysaccharide, rheology modifiers, etc. These additives or chemicals may thus be process chemicals or film performance chemicals added to provide the end product film with specific properties and/or to facilitate production of the film.

In some embodiments, the MFC suspension further comprises at least one additive selected from the group of film forming agents, dispersants, plasticizers, softeners, mineral additives, humectants and rheology modifiers.

In some embodiments, the suspension medium is or comprises water, and the MFC suspension further comprises at least one water-soluble additive. In some embodiments, the suspension medium is or comprises water, and the MFC suspension further comprises at least one water-soluble polymer that can form a film and/or improve binding between cellulose fibrils. Typical examples of such polymers are natural gums or polysaccharides or derivatives thereof such as carboxymethylated cellulose (CMC), starch, or polyvinyl alcohol (PVOH) or derivatives or analogues thereof.

In some embodiments, the suspension medium is or comprises water, and the MFC suspension further comprises at least one water-soluble additive selected from the group of: PVOH and derivatives or analogues thereof, starch, CMC, sorbitol and polyethylene glycol.

The PVOH may be a single type of PVOH, or it can comprise a mixture of two or more types of PVOH, differing e.g., in degree of hydrolysis or viscosity. The PVOH may for example have a degree of hydrolysis in the range of 80-99 mol %, preferably in the range of 88-99 mol %.

Since the MFC film is formed and retained on the non-porous support until after dewatering and/or drying (and further until after the polymer film application and pressing steps) according to the first aspect of the method, film additives, including water-soluble film additives, are to a greater extent retained in the MFC film compared to when a porous support is utilized. In some embodiments, the MFC suspension is free of cationic or amphoteric retention agents, fixatives and flocculation agents.

In some embodiments, the MFC suspension comprises no more than 50 weight-%, such as no more than 35 weight-% or no more than 30 weight-% or no more than 25 weight-% or no more than 20 weight-%, of additives based on total dry weight of the MFC suspension. For example, the MFC suspension may comprise 1-50 weight-% or 1-35 weight-% or 1-30 weight-% or 1-25 weight-% or 1-20 weight-% of additives, based on total dry weight of the MFC suspension.

In some embodiments, the MFC suspension comprises 0.5-20 weight-% of a plasticizing agent based on total dry weight of the MFC suspension, such as sorbitol, glycol, other polyol or a combination thereof.

In some embodiments, the MFC suspension comprises up to 30 weight-% of nanocrystalline and/or cellulose derivatives, based on total dry weight of the MFC suspension.

In some embodiments, the MFC suspension comprises up to 20 weight-% of mineral fillers (regular filler or nanofiller) based on total dry weight of the MFC suspension, such as bentonite, kaolin, talcum, mica, montmorillonite, organoclays, graphene, graphene oxide or a combination thereof.

As mentioned above, the method of the first aspect comprises a step of forming a wet MFC film on a non-porous support. The wet MFC film is formed on the non-porous support by casting, such as cast coating, the MFC suspension onto the non-porous support, such as onto a casting surface of the non-porous support. As mentioned above, the MFC suspension has a dry content of 1-40 weight-%. Thus, the formed wet MFC film has a dry content of 1-40 weight-% at formation (i.e., during application on the metal belt support or immediately after application/formation on the metal belt support).

The term “casting”, when utilized in film-forming, is a known term designating methods wherein a suspension is deposited by means of contact or non-contact deposition and levelling methods on a support to form a wet web. Examples of such a deposition and levelling method are curtain coating/application, slot die casting, or dosing the MFC suspension with spray or similar device and leveling with a doctor-blade or rod.

The non-porous support on which the wet MFC film is formed in the method of the first aspect may be a metal belt (i.e., a belt made of metal) such as a steel belt, a polymer belt or a polymer coated belt. A metal belt may be coated, e.g., with ceramic material. The non-porous support may be a continuous or endless non-porous support, such as a conveyor belt.

In some embodiments, the non-porous support is a metal belt support having a smooth casting surface, i.e., a smooth surface on which the MFC suspension is casted. In some embodiments, the metal belt support has a casting surface with a smoothness resulting in a Bendtsen roughness of 200 ml/min or less, preferably 150 ml/min or less, more preferably 100 ml/min or less, as measured by ISO 8791-2:2013 and/or a Parker Print-Surf (PPS) smoothness of 10 μm or less, preferably 0.1-5 μm or less, most preferably 0.3-5 μm or less, as determined according to ISO 8791-4, of the side of the produced MFC film being in contact with the casting surface of the metal belt support. Alternatively, the casting surface of the metal belt support is textured. Also, the metal belt support has a reverse surface opposite the casting surface.

It is important to apply the MFC suspension to the casting surface of the non-porous support in such a way that a homogeneous wet MFC film is formed, meaning that the wet MFC film should be as uniform as possible with as even thickness as possible etc. The formed wet MFC film is formed of an amount of the MFC suspension corresponding to a dry grammage (basis weight) of 2-70 g/m², preferably 3-70 g/m² such as 8-70 g/m² or 10-60 g/m² or 10-50 g/m² or 15-40 g/m². The dry MFC film may be translucent or transparent.

According to the method of the first aspect, the MFC suspension has a dry content of 1-40 weight-%, preferably 2-25 weight-%, more preferably 3-15 weight-%, most preferably 3.5-8 weight-%. Thus, the formed wet MFC film has a dry content of 1-40 weight-%, preferably 2-25 weight-%, more preferably 3-15 weight-%, most preferably 3.5-8 weight-%, at formation.

Preferably, the MFC suspension is in direct contact with the casting surface of the non-porous support after casting. However, in some embodiments a coating for controlling adhesion and release properties may be applied on the casting surface of the non-porous support, before the MFC suspension is casted on the casting surface. Examples of agents of such a coating are poly(aminoamide)-epihalohydrin polymer (PAE) resins, polyvinyl alcohol resins (PVOH), polyvinyl alcohol copolymers, starches, ethylene glycol, vegetable oils, fatty acids and sugar alcohols.

The formed wet MFC film can be a single or multilayer film or single ply or multiply film, made with one or several casting units. Thus, in some embodiments, the wet MFC film comprises a single film layer or two or more film layers formed on top of each other.

As mentioned above, the method of the first aspect comprises dewatering and/or drying the wet MFC film to a dry MFC film having a moisture content of 20 weight-% or less, preferably 10 weight-% or less, most preferably 5 weight-% or less. In some embodiments, the dry MFC film has a moisture content of 1-20 weight-%. The moisture content may be measured under ambient conditions. For example, the moisture content may be measured using spectroscopy methods, such as infra-red (IR) spectroscopy, near infra-red (NIR) spectroscopy or Raman spectroscopy methods, in particular infra-red methods suitable for single side measurement. Alternatively, the dry content may be measured in order to determine the moisture content. For example, the dry content may be measured according to standard 638 and the moisture content may be calculated based on the dry content measurement.

The wet MFC film is positioned on the non-porous support during the dewatering and/or drying. The dewatering and the drying, respectively, may be performed by using any methods known in the art that are suitable to provide the dry MFC film.

For example, the dewatering may be performed by wet-pressing of the wet MFC film positioned on the non-porous support, such as by mechanical dewatering by applying a press fabric in direct contact with the wet MFC film and conducting the wet MFC film, arranged between the press fabric and the non-porous support, through a pressing equipment. Optionally, mechanical dewatering may be combined with evaporation provided by applying heat or radiation. With press fabric is meant a fabric that is permeable and allows water to be removed from the wet MFC film either by absorbing the water or by allowing the water to be removed through the fabric. The press fabric may be a press felt (dewatering felt). Press fabrics and press felts are today often used for dewatering of paper and paperboard webs. Any known suitable press fabric or press felt may be utilized. With pressing equipment is meant an equipment comprising one or more nip through which the wet MFC film is conducted and thus pressed and dewatered. The pressing equipment may have a metal backing surface, which for example may be a hard roller. External loading elements may be utilized in order to press the non-porous support and the backing surface against each other to create the pressure. The pressing equipment may comprise an extended nip. For example, the pressing equipment may be a belt press. The dewatering may be performed in one or more sub-steps, i.e., the dewatering step may comprise one or more sub-steps.

For example, the drying may be performed by contact drying, such as cylinder drying, infrared (IR) drying, near infrared (NIR) drying, microwave (MW) drying, ultra-violet (UV) drying, electron beam (EB) drying, hot gas impingement drying such as hot air impingement drying, any other radiation drying or a combination thereof. The drying may be performed in one or more sub-steps, i.e., the drying step may comprise one or more sub-steps.

In some embodiments, the method of the first aspect comprises a dewatering step during which the wet MFC film is dewatered to the dry MFC film. In some embodiments, the method of the first aspect comprises a drying step during which the wet MFC film is dried to the dry MFC film. In some embodiments, the method of the first aspect comprises a dewatering step and a drying step during which the wet MFC film is dewatered and dried, respectively, to the dry MFC film.

In embodiments comprising a dewatering step, the method may further include a step of pre-drying the wet MFC film before the step of dewatering. For example, the pre-drying step may be necessary to perform when the dry content of the wet MFC film is 1-20 weight-%, or 1-15 weight-% or 1-10 weight-%. The pre-drying may be performed by any of the drying techniques described above for the drying step.

In embodiments in which the non-porous support is a metal belt support, the metal belt support may be heated to a temperature above 30° C., preferably such that at least the casting surface of the metal belt has a temperature between 30-150° C., more preferably between 45-150° C., even more preferred between 60-100° C. before or immediately after the wet MFC film is applied to the metal belt support and the temperature of the metal belt support may be kept during parts of the method for producing the barrier substrate, e.g., during at least some process steps for production of the dry MFC film, or during the complete method for producing the barrier substrate. By increasing the temperature of the metal belt support and thus on the applied wet MFC film it is possible to further increase the efficiency of the pre-drying, dewatering and/or drying of the wet MFC film.

Accordingly, after the dewatering and/or drying a dry MFC film is obtained having a moisture content of 20 weight-% or less, preferably 10 weight-% or less, most preferably 5 weight-% or less. The obtained dry MFC film is still positioned on the non-porous support. The dry MFC film has a first side and an opposite second side, wherein the second side is in contact with the non-porous support (possibly via any coatings on the non-porous support).

In some embodiments, the dry MFC film has a dry grammage of 2-70 g/m², preferably 3-70 g/m² such as 4-70 g/m² or 8-70 g/m² or 10-60 g/m² or 10-50 g/m² or 15-40 g/m².

In some embodiments, the dry MFC film has a tensile index of 15-150 Nm/g, or 20-140 Nm/g or 30-120 Nm/g in machine direction as measured according to standard ISO 1924-3 with test span (initial distance between clamps) of 20 mm and speed 2 mm/min.

In some embodiments, an average film thickness of the dry MFC film is 5-60 μm, preferably 10-50 μm, 15-45 μm or 20-40 μm. Particular average film thicknesses may be 5-10 μm, 10-15 μm, 15-20 μm, 20-25 μm, 25-30 μm, 30-35 μm, 35-40 μm, 40-45 μm, 45-50 μm, 50-55 μm or 55-60 μm. The average film thickness may be defined as an average thickness of the film across the entire width. Thickness of the MFC film may be measured using, as non-limiting examples, white light interferometry, laser profilometry, or optically by cutting a sample in cross-machine directional line (either cast in resin or not) and microscopic imaging (e.g., scanning electron microscopy or other applicable method) of the cut section in thickness direction.

In some embodiments, a width of the dry MFC film of the second web is 0.3-4 m, preferably 0.5-4 m, 1-4 m or 2-4 m.

In some embodiments, the dry MFC film has an oxygen transmission rate (OTR), measured according to the standard ASTM F 1927-20 at 50% relative humidity and 23° C., of less than 50 cc/m²/24 h, preferably less than 20 cc/m²/24 h, most preferably less than 10 cc/m²/24 h.

In some embodiments, the dry MFC film has a water vapor transmission rate (WVTR), measured according to the standard ASTM F 1249-20 at 50% relative humidity and 23° C., of less than 100 g/m²/24 h, preferably less than 50 g/m²/24 h, and more preferably less than 20 g/m²/24 h.

In some embodiments, the dry MFC film has a KIT value of at least 10, preferably 12, as measured according to standard ISO 16532-2.

In some embodiments, the dry MFC film has less than 10 pinholes/m², preferably less than 6 pinholes/m².

As mentioned above, the method of the first aspect comprises a step of applying a first polymer film on a first side of the dry MFC film to form an intermediate substrate.

The dry MFC film is positioned on the non-porous support during the step of applying the first polymer film.

In some embodiments, the first polymer film comprises or consists of a thermoplastic polymer. In some embodiments, the first polymer film comprises or consists of a polymer selected from the group consisting of polyolefins and polyesters. In some embodiments, the first polymer film comprises or consists of a polymer selected from the group consisting of thermoplastic polyolefins and thermoplastic polyesters. In some embodiments, the first polymer film comprises or consists of polypropylene or polyethylene. In some embodiments, the first polymer film comprises or consists of polyethylene, more preferably LDPE or HDPE.

The first polymer film may comprise or consist of any of the thermoplastic polymers commonly used in protective and/or heat-sealable layers in paper or paperboard based packaging laminates in general or polymers used in liquid or food packaging board in particular. Examples include polyethylene (PE), polyethylene terephthalate (PET), polyethylene furanoate (PEF), polypropylene (PP), polyhydroxyalkanoates (PHA), polylactic acid (PLA), polyglycolic acid (PGA), starch and cellulose. Polyethylenes, especially low density polyethylene (LDPE) and high density polyethylene (HDPE), are the most common and versatile polymers used in liquid or food packaging board. The polymers used are preferably manufactured from renewable materials. Thermoplastic polymers are useful since they can be conveniently processed by extrusion coating techniques to form very thin and homogenous films with good liquid barrier properties. The first polymer film may, for example, be applied by extrusion coating or film lamination. The first polymer film may have an average thickness of 5-100 μm, or 8-60 μm, or 10-40 μm. The first polymer film may comprise one or more sub-layers.

In some embodiments, the first polymer film comprises or consists of a component selected from adhesive thermoplastic polymers, such as modified polyolefins, which are mostly based on LDPE or LLDPE co-polymers or, graft co-polymers with functional-group containing monomer units, such as carboxylic or glycidyl functional groups, e.g., (meth)acrylic acid monomers or maleic anhydride (MAH) monomers, (i.e., ethylene acrylic acid copolymer (EAA) or ethylene methacrylic acid copolymer (EMAA)), ethylene-glycidyl(meth)acrylate copolymer (EG(M)A) or MAH-grafted polyethylene (MAHg-PE). Another example of such modified polymers or adhesive polymers are so called ionomers or ionomer polymers. Preferably, the modified polyolefin is an ethylene acrylic acid copolymer (EAA) or an ethylene methacrylic acid copolymer (EMAA).

Extrusion coating is a process by which a molten plastic material is applied to a substrate to form a very thin, smooth uniform layer. The coating can be formed by the extruded plastic itself, or the molten plastic can be used as an adhesive to laminate a solid plastic film onto the substrate. Common plastic resins used in extrusion coating include polyethylene (PE), polypropylene (PP), and polyethylene terephthalate (PET).

In some embodiments, the first polymer film is applied on the first side of the dry MFC film, which is positioned on the non-porous support, in melt form by extrusion coating.

In some embodiments, the first polymer film is applied on the first side of the dry MFC film in the form of a solid film. In these embodiments, the solid first polymer film may comprise an adhesive, such as selected from polysaccharides, e.g., starch or starch derivatives, hemicellulose cellulose and cellulose derivatives, which provides adhesion between the first polymer film and the MFC film. Alternatively, an adhesive, such as selected from polysaccharides, polyvinyl alcohol, polyurethanes, polyolefins and polyesters, may be applied on the first side of the dry MFC film or on the solid first polymer film before the solid first polymer film is applied to the dry MFC film in these embodiments. Still alternatively, the solid first polymer film may comprise a thermoplastic polymer which is melted during the subsequent pressing step, possibly in combination with heating.

In some embodiments, the first polymer film is a solid film, wherein at least one surface of the solid first polymer film is provided with a vacuum coating layer. The vacuum coating layer may be inorganic or organic. In some embodiments, the vacuum coating layer is an inorganic vacuum coated layer, such as a metal, metal oxide, or ceramic vacuum coating layer.

In some embodiments, at least one surface of the solid first polymer film is metallized. In some embodiments, the metallized surface of the solid first polymer film is formed by vapor deposition of a metal or metal oxide on the surface of the solid first polymer film, i.e., a vacuum coating layer comprising a metal or metal oxide is provided on the surface of the solid first polymer film.

In some embodiments, the vacuum coating layer comprises a metal or metal oxide selected from the group consisting of aluminum, magnesium, silicon, copper, aluminum oxides, magnesium oxides, silicon oxides, and combinations thereof, preferably an aluminum oxide.

Vacuum coating, or vacuum deposition coating, refers to a family of processes used to deposit layers of metals, metal oxides and other inorganic and organic compositions, typically atom-by-atom or molecule-by-molecule, on a solid surface. Multiple layers of the same or different materials can be combined. The process can be further specified based on the vapor source; physical vapor deposition (PVD) uses a liquid or solid source and chemical vapor deposition (CVD) uses a chemical vapor. Atomic layer deposition (ALD) may also be utilized.

Vacuum coating typically results in very thin coatings. The vacuum coating layer may comprise one or more sublayers. In some embodiments, the vacuum coating layer has a total thickness in the range of 10-600 nm, preferably in the range of 10-250 nm, and more preferably in the range of 50 -250 nm. This may be compared to conventional aluminum foils used in packaging laminates, which foils typically have thickness in the range of about 3-12 μm.

In some embodiments, the vacuum coating layer is applied to the solid first polymer film by PVD or CVD. In some embodiments, the vacuum coating layer is applied to the solid first polymer film by ALD, PVD, CVD or variants of PVD and CVD, such as plasma enhanced chemical vapor deposition (PECVD).

One preferred type of vacuum coating, often used for its barrier properties, in particular water vapor barrier properties, is an aluminum metal PVD coating. Such a coating, substantially consisting of aluminum metal, may typically have a thickness of from 50 to 250 nm, although a thickness even lower than 50 nm may also be useful, and even preferred in some embodiments. The thickness of the vacuum coating layer corresponds to less than 1% of the aluminum metal material typically present in an aluminum foil of conventional thickness for packaging, i.e., 6.3 μm. Thus, in some embodiments, the vacuum coating layer comprises aluminum.

The thickness of the vacuum coating layer may also be characterized by the optical density of the layer. In some embodiments the vacuum coating layer has an optical density above 1.8, preferably above 2.0, above 2.5, above 2.7, or above 3.0.

Aluminum oxide vacuum coating layers also known as AlOx coatings can provide similar barrier properties as aluminum metal coatings but have the added advantage of thin AlOx coatings being transparent to visible light.

In some embodiments, the vacuum coating layer is an organic vacuum coated layer. In some embodiments, the vacuum coating layer comprises carbon.

The organic vacuum coating may for example be a vacuum coated carbon layer, such as a diamond-like carbon (DLC) layer formed from carbon or organic compounds.

Optionally, one or more top layers may be provided on the vacuum coating layer. For example, one or more protective layers may be provided on the vacuum coating layer for protecting the sensitive vacuum coating layer before applying the solid first polymer film to the MFC film. Alternatively, or additionally, one or more primer layers may be provided on the vacuum coating layer for improving the adhesion of the vacuum coating layer.

In some embodiments, a pre-coat layer is applied to the solid first polymer film before the vacuum coating deposition.

In some embodiments, the first polymer film is a foamed film. In these embodiments, the first polymer film is applied in the form of a foam. In some embodiments, the first polymer film is a low density film such as a polymer film having a density of 100-1000 kg/m³ or 150-750 kg/m³ or 250-500 kg/m³.

As mentioned above, the method of the first aspect comprises a step of pressing the intermediate substrate (which comprises the MFC film and the first polymer film applied thereon) positioned on the non-porous support in at least one nip to form the barrier substrate. By means of the pressing step the first polymer film and the MFC film are pressed together to form the barrier substrate, i.e., the adhesion between the first polymer film and the MFC film is improved.

Each of the at least one nip may be selected from the group of a lamination nip, calender nip, a smoothing roll nip, a press nip, a belt nip and an extended nip, such as comprising one belt and the support belt. The linear load of each of the at least one nip may be 0.1-200 kN/m, preferably 1-150 kN/m, most preferably 5-100 kN/m. In some embodiments, the absolute pressure of the at least one press device is 1-25000 kPa, preferably 3-17000 kPa.

In some embodiments, the pressing of the intermediate substrate is combined with heating of the intermediate substrate in order to improve the adhesion between the first polymer film and the MFC film. Depending on the polymer of the first polymer film and the method of application of the first polymer film, heating may be needed in order for the first polymer film and the MFC film to adhere to each other. In some embodiments, the intermediate substrate is heated before entering the pressing step, i.e., before entering the at least one nip. For example, the temperature of the dry MFC film or of the intermediate substrate may be 60-250° C., such as 70-250° C. or 80-250° C., before or when entering the at least one nip. Additionally, or alternatively, one or more nip of the at least one nip may be heated, e.g., by one or more nip roll being heated or by hot air being introduced into the nip.

In some embodiments the first polymer film is heated before contacting the MFC film in order to soften or melt the first polymer film to improve the adhesion between MFC film and the first polymer film. For example, the temperature of the first polymer film may be 80-350° C., such as 120-300° C. or 140-250° C., before or when contacting the MFC film. The at least one nip following contact point of MFC film and first polymer film may be cooled.

In some embodiments, the first polymer film is extruded onto a first roll, which is a cooled roll or a non-tempered roll and which form a nip of the one or more nip. Thus, in these embodiments the first polymer film is applied to the dry MFC film by the first roll at the same time as the dry MFC film and the first polymer film are pressed together by the first roll.

In some embodiments, the method further comprises a step of subjecting the barrier substrate to at least one cooling nip after the step of pressing. For example, the barrier substrate may be cooled to a temperature of 10-70° C. The step of cooling may be particularly important when heating is applied in the pressing step. The step of cooling may be performed in order to avoid blocking and to control e.g., curl of the barrier substrate. The cooling step may be performed before or after removal of the barrier substrate from the non-porous support, preferably after removal from the non-porous support.

As mentioned above, the method of the first aspect comprises a step of separating the barrier substrate from the non-porous support, i.e., separating (e.g., peeling off) the barrier substrate from the non-porous support after the pressing step.

In some embodiments, the method of the first aspect further comprises a step of applying a second polymer film on the second side of the MFC film of the barrier substrate after the barrier substrate is separated and removed from the non-porous support, wherein the second side of the MFC film is opposite the first side of the MFC film.

The definition of the second polymer film may correspond to the definition of the first polymer film. Thus, in some embodiments the second polymer film comprises or consists of a thermoplastic polymer. In some embodiments, the second polymer film comprises or consists of a polymer selected from the group consisting of polyolefins and polyesters. In some embodiments, the second polymer film comprises or consists of a polymer selected from the group consisting of thermoplastic polyolefins and thermoplastic polyesters. In some embodiments, the second polymer film comprises or consists of polypropylene or polyethylene. In some embodiments, the second polymer film comprises or consists of polyethylene, more preferably LDPE or HDPE.

The second polymer film may comprise or consist of any of the thermoplastic polymers commonly used in protective and/or heat-sealable layers in paper or paperboard based packaging laminates in general or polymers used in liquid or food packaging board in particular mentioned above. The second polymer film may, for example, be applied by extrusion coating, film lamination or dispersion coating. For example, dispersion coating may be performed by dispersions of PVOH, polysaccharides, latex emulsions such as styrene/acrylate, acrylics and acrylic copolymers, vinyl acetate, polyurethanes, styrene/butadiene, etc.

In some embodiments, the second polymer film is applied on the second side of the dry MFC film in melt form by extrusion coating.

In some embodiments, the second polymer film is applied on the second side of the dry MFC film in the form of a solid film. In these embodiments, the solid second polymer film may comprise an adhesive, such as selected from polysaccharides, e.g., starch or starch derivatives, hemicellulose cellulose and cellulose derivatives, which provides adhesion between the second polymer film and the MFC film. Alternatively, an adhesive, such as selected from polysaccharides, polyvinyl alcohol, polyurethanes, polyolefins and polyesters, may be applied on the second side of the MFC film or on the solid second polymer film before the solid second polymer film is applied to the second side of the MFC film in these embodiments.

In some embodiments, the second polymer film is a solid film, wherein at least one surface of the solid second polymer film is provided with a vacuum coating layer. The vacuum coating layer may be defined as above in connection with the solid first polymer film.

In some embodiments, at least one surface of the solid second polymer film is metallized. In some embodiments, the metallized surface of the solid second polymer film is formed by vapor deposition of a metal or metal oxide on the surface of the solid second polymer film, i.e., a vacuum coating layer comprising a metal or metal oxide is provided on the surface of the solid second polymer film, preferably by physical vapor deposition (PVD) or chemical vapor deposition (CVD).

In some embodiments, a pre-coat layer is applied to the solid second polymer film before the vacuum coating deposition.

In some embodiments, the second polymer film is a foamed film. In these embodiments, the second polymer film is applied in the form of a solid foam.

The basis weight of the first polymer film and the optional second polymer film, respectively, is preferably less than 50 g/m². In order to achieve a continuous and substantially defect free film, a basis weight of each of the polymer films of at least 6 g/m², preferably at least 8 g/m², is typically required if provided by extrusion coating. In some embodiments, the basis weight of the first polymer film and the optional second polymer film, respectively, is in the range of 6-50 g/m², preferably in the range of 10-20 g/m², wherein the polymer films are provided by extrusion coating. In some embodiments, the basis weight of the first polymer film and the optional second polymer film, respectively, is in the range of 2-10 g/m², wherein the polymer films are provided by foamed film.

In some embodiments, the obtained barrier substrate has an oxygen transmission rate (OTR), measured according to the standard ASTM F 1927-20 at 50% relative humidity and 23° C., of less than 20 cc/m²/24 h, preferably less than 15 cc/m²/24 h, most preferably less than 10 cc/m²/24 h.

In some embodiments, the obtained barrier substrate has a water vapor transmission rate (WVTR), measured according to the standard ASTM F 1249-20 at 50% relative humidity and 23° C., of less than 50 g/m²/24 h, preferably less than 30 g/m²/24 h, and more preferably less than 20 g/m²/24 h.

In some embodiments, the obtained barrier substrate has a KIT value of at least 10, preferably 12, as measured according to standard ISO 16532-2.

According to a second aspect of the present disclosure there is provided a barrier substrate comprising an MFC film and a first polymer film, which barrier substrate is obtainable by the method of the first aspect.

The barrier substrate obtainable by the method of the first aspect can be used as such. Alternatively, it can be combined with one or more further layers, such as one or more further paper or paperboard layers, into a laminate.

According to a third aspect of the present disclosure there is provided a method for producing a laminate, wherein the method comprises the steps of:
providing a paper or paperboard substrate,
providing a barrier substrate according to the method according to the first aspect, and
joining a first surface of the paper or paperboard substrate with the MFC film of the barrier substrate using at least one tie layer to obtain the laminate.

Paper generally refers to a material manufactured in thin sheets from the pulp of wood or other fibrous substances comprising cellulose fibers, used for writing, drawing, or printing on, or as packaging material. Paper can either be bleached or unbleached, coated or uncoated, and produced in a variety of thicknesses, depending on the end use requirements. Paper may be a single ply material, or a multiply material comprised of two or more plies.

Paperboard generally refers to strong, thick paper or cardboard comprising cellulose fibers used for boxes and other types of packaging. Paperboard can either be bleached or unbleached, coated or uncoated, and produced in a variety of thicknesses, depending on the end use requirements. Paperboard may be a single ply material, or a multiply material comprised of two or more plies. A common type of multiply paperboard is comprised of a lower density mid-ply (also sometimes referred to as “bulk ply”) sandwiched between two higher density outer plies. The lower density mid-ply may typically have a density below 750 kg/m³, preferably below 700, below 650, below 600, below 550, below 500, below 450, below 400 or below 350 kg/m³. The higher density outer plies typically have a density at least 100 kg/m³ higher than the mid-ply, preferably at least 200 kg/m³ higher than the mid-ply.

The paper or paperboard used as a substrate in accordance with the present disclosure can be made from pulp, including pulp from virgin fiber, e.g., mechanical, semi-chemical, chemical and/or thermomechanical pulps. It can also be made from broke or recycled paper or paperboard. The paper or paperboard used as a substrate in accordance with the present disclosure is prepared using methods known in the art.

In some embodiments, the paper or paperboard substrate comprises at least 10% recycled material, such as at least 20% or at least 40% or at least 50% or at least 60% or at least 70% recycled material, which can be either pre-or post-consumer grade.

The paper substrate used in the method of the third aspect has preferably a grammage in the range of 10-200 g/m², more preferably in the range of 20-100 g/m². Unless otherwise stated, the grammage is determined according to the standard ISO 536.

The paperboard substrate used in the method of the third aspect has preferably a grammage in the range of 120-600 g/m² or 120-450 g/m², more preferably in the range of 200-500 g/m² or 180-380 g/m². Unless otherwise stated, the grammage is determined according to the standard ISO 536.

The paper or paperboard substrate may be a single ply paper or paperboard or a multiply paper or paperboard. In some embodiments, the paperboard substrate is a multiply paperboard. In some embodiments, the paperboard substrate is a multiply paperboard comprised of two or more plies. In some embodiments, the paperboard substrate is a multiply paperboard comprised of three or more plies. In some embodiments, the paperboard substrate is a multiply paperboard comprised of a lower density mid-ply sandwiched between two higher density outer plies.

In some embodiments, the paperboard substrate is a foam formed paperboard. In some embodiments wherein the paperboard substrate is a multiply paperboard, at least one of the plies, preferably a mid-ply, is foam formed. In some embodiments wherein the paperboard substrate is a multiply paperboard, at least one of the plies, preferably a mid-ply, is a bulky ply.

The paper or paperboard substrate is optionally coated, such as mineral coated, to improve smoothness and printability. Such mineral coating may be provided on one or both sides of the substrate and is then a part of the substrate in the context of the present disclosure. The paper or paperboard substrate may be subjected to surface sizing or surface treatment on at least one side of the substrate. Such surface sizing or surface treatment is then part of the paper or paperboard substrate in the context of the present disclosure. Preferably, a surface sizing composition used for surface sizing comprises starch or a starch derivative.

The tie layer may comprise any suitable adhesive commonly used in paper or paperboard based packaging laminates in general or adhesives used in liquid or food packaging laminates in particular. Many different types of adhesives and adhesive coating methods may be used with the invention.

The tie layer may comprise one or more adhesive polymers. The tie layer may be comprised entirely of the one or more adhesive polymers, or it may also further comprise other additives for improving the properties of the adhesive layer. In some embodiments, the tie layer comprises at least 50 weight-% of an adhesive polymer or mixture of adhesive polymers based on dry weight. In some embodiments, the tie layer comprises or consists of one or more adhesive polymers selected from the group consisting of polyolefins, polyesters, polyurethanes, and acrylic copolymers. In some embodiments, the tie layer comprises or consists of one or more of polypropylene and polyethylene, such as LLDPE, LDPE, MDPE or HDPE.

In some embodiments, the tie layer comprises or consists of a component selected from adhesive thermoplastic polymers, such as modified polyolefins, which are mostly based on LDPE or LLDPE co-polymers or, graft co-polymers with functional-group containing monomer units, such as carboxylic or glycidyl functional groups, e.g., (meth)acrylic acid monomers or maleic anhydride (MAH) monomers, (i.e., ethylene acrylic acid copolymer (EAA) or ethylene methacrylic acid copolymer (EMAA)), ethylene-glycidyl(meth)acrylate copolymer (EG(M)A) or MAH-grafted polyethylene (MAHg-PE). Another example of such modified polymers or adhesive polymers are so called ionomers or ionomer polymers. Preferably, the modified polyolefin is an ethylene acrylic acid copolymer (EAA) or an ethylene methacrylic acid copolymer (EMAA).

In some embodiments, the tie layer comprises at least 50 weight-% of a water-soluble polymer or mixture of water-soluble polymers based on dry weight. The water-soluble polymer of the tie layer is soluble in cold water or soluble in hot water, e.g., at a temperature below 100° C. or even above 100° C., for a given period of time. In some embodiments, the water-soluble polymer is selected from the group consisting of a PVOH or derivatives or analogues thereof, a CMC, a starch, an alginate, and a hemicellulose, preferably a PVOH.

The tie layer may be applied by any suitable method known in the art. The total coat weight of the one or more tie layers may generally be in the range of 1-30 g/m². In some embodiments, the total coat weight of the one or more tie layers is in the range of 2-25 g/m², more preferably in the range of 3-20 g/m².

In some embodiments, the first polymer film or the second polymer film of the barrier substrate may act as a tie layer. The first polymer film or the second polymer film may be activated with heat before joining it in paper or paperboard substrate.

The method of the third aspect may further comprise a step of providing the laminate with an outermost polymer layer on one side or on both sides. However, the first polymer film of the barrier substrate may constitute an outermost polymer layer of the laminate. The outermost polymer layers preferably provide liquid barrier properties and mechanical protection for the laminate surface(s). The outermost polymer layers are preferably also heat-sealable. The outermost polymer layers may for example be applied by extrusion coating, film lamination or dispersion coating after the laminate is formed. The outermost polymer layers may comprise any of the thermoplastic polymers commonly used in protective and/or heat-sealable layers in paper-based packaging laminates in general or polymers used in liquid or food packaging board in particular. In some embodiments, the outermost polymer layers comprise polypropylene or polyethylene. In preferred embodiments, the outermost polymer layers comprise polyethylene, more preferably LDPE or HDPE. The basis weight of the outermost polymer layer(s) may correspond to the basis weight of the first polymer layer.

The laminate produced by the method of the third aspect is a paper or paperboard based laminate, i.e., a laminate formed mainly from paper or paperboard, such as a paper or paperboard based packaging laminate. The laminate has typically a first outermost surface which may be intended to serve as the outside surface, or print side, and a second outermost surface which may be intended to serve as the inside surface of a packaging container. The side of the paper or paperboard substrate comprising the MFC film may be intended to serve as the inside surface of a packaging container.

According to a fourth aspect of the present disclosure there is provided a laminate obtainable by the method of the third aspect. The laminate obtainable by the method of the third aspect can be used as such. Alternatively, it can be combined with one or more further layers.

For example, the barrier substrate and the laminate of the present disclosure can be used as a packaging material or in a packaging material, such as a food or liquid packaging material. For example, the barrier substrate and laminate can be part of a flexible packaging material, such as a free-standing pouch or bag, which may be opaque or translucent. Thus, the barrier substrate and the laminate may be used as bag material in boxes when packaging dry food such as cereals. Furthermore, the barrier substrate and the laminate may be used as a wrapping substrate, such as a flow wrap material, as a laminate material in paper, paperboard or plastics and/or as a substrate for disposable electronics. The barrier substrate and the laminate may also be included in, for example, a closure, a lid or a label. The barrier substrate and the laminate can be incorporated into any type of package, such as a box, bag, wrap, wrapping film, cup, container, tray, bottle, etc. The present disclosure also relates to a packaging product comprising the barrier substrate obtainable by the method of the first aspect or the laminate obtainable by the method of the third aspect. Furthermore, the present disclosure relates to use of a barrier substrate obtainable by the method of the first aspect or the laminate obtainable by the method of the third aspect as a packaging material or in a packaging material.

Some examples of possible structures of the barrier substrate according to the present disclosure are shown below:

MFC film/polymer film
MFC film/adhesive/polymer film
MFC film/adhesive/metallized layer/polymer film
polymer film/MFC film/polymer film
polymer film/MFC film/adhesive/polymer film
polymer film/MFC film/adhesive/metallized layer/polymer film
MFC film/polymer film/metallized layer/polymer film

Some examples of possible structures of the laminate according to the present disclosure are shown below:
paperboard/tie layer/MFC film/polymer film
paperboard/tie layer/MFC film/adhesive/polymer film
paperboard/tie layer/MFC film/adhesive/metallized layer/polymer film
polymer film/paperboard/tie layer/MFC film/polymer film
polymer film/paperboard/tie layer/MFC film/polymer film/polymer film
polymer film/paperboard/tie layer/MFC film/adhesive/polymer film
polymer film/paperboard/tie layer/MFC film/adhesive/metallized layer/polymer film

### EXAMPLES

### Example 1—Extrusion Coating Polyolefin onto MFC Film

Hardwood pulp was subjected to enzymatic treatment and then to mechanical disintegration with conditions as described in, for example, WO2007091942A1. The MFC suspension was then mixed with 10 wt % polyvinyl alcohol, 10 wt % clay and 5 wt % of sugar alcohol (based on MFC dry solid content). The MFC suspension was then cast coated with slot die technology onto a metal belt for forming a 15 g/m² thin wet MFC film (dry weight) at a consistency of 5.0 wt %. The wet MFC film was dewatered and dried on the metal belt until a moisture content less than 4 wt % to form a dry MFC film, before contacting the dry MFC film with a polyolefin melt. The dry MFC film was still positioned on the metal belt when the polyolefin melt was applied on the dry MFC film. The polyolefin melt, metallocene-LDPE, was applied in an amount of 20 gsm to form a barrier substrate. The melt was fused together and levelled on the MFC film with temperature of 80° C. and at a pressure of 10 KN/m. Thereafter the barrier substrate was subjected to a cooling step. The obtained barrier substrate had an OTR value of 1-10 cc/m2/day measured according to ASTM F 1927-20 at 23° C. and 50% RH and WVTR <20 g/m2/day measured according to ASTM F 1249-20 at 23° C. and 50% RH.

### Example 2—Laminating Metallized Biaxially Oriented PP to MFC Film

The MFC film was prepared in the same way as described in Example 1. After drying, and when the dry MFC film was still attached to the metal belt, a biaxially oriented metallized polypropylene film with adhesive layer was attached to the dry MFC film to form an intermediate substrate. The intermediate substrate was further heated and fused in a nip with a nip temperature of 160° C. (upper roll, not metal belt) and a nip pressure of 5-10 kN/m in order to ensure good adhesion with the MFC film and a barrier substrate was formed. The obtained barrier substrate had an OTR value <3 cc/m²/24 h measured according to ASTM F 1927-20 at 23° C. and 50% RH and a WVTR value <3 g/m²/24 H measured according to ASTM F 1249-20 at 23° C. and 50% RH. The structure of the barrier substrate before adding further layers was MFC film/adhesive/metallization layer/BOPP.

Generally, while the products, materials, layers and processes are described in terms of “comprising” various components or steps, the products, materials, layers and processes can also “consist essentially of” or “consist of” the various components and steps.

In view of the above detailed description of the present invention, other modifications and variations will become apparent to those skilled in the art. However, it should be apparent that such other modifications and variations may be effected without departing from the spirit and scope of the invention.

1. A method for producing a barrier substrate comprising a microfibrillated cellulose (MFC) film and a polymer film, wherein the method comprises the steps of:
providing an MFC suspension comprising between 50 weight-% to 100 weight-% MFC based on a_total dry weight, wherein said MFC suspension has a dry content of 1-40 weight-%;
forming a wet MFC film of said MFC suspension by casting on a non-porous support;
dewatering, or drying, or both said wet MFC film positioned on said non-porous support to provide a dry MFC film having a moisture content of 20 weight-% or less;
applying a first polymer film on a first side of said dry MFC film positioned on said non-porous support to form an intermediate substrate,
pressing said intermediate substrate positioned on said non-porous support in at least one nip to form said barrier substrate, and
separating said barrier substrate from said non-porous support.

2. The method according to claim 1, wherein said first polymer film comprises a thermoplastic polymer.

3-4. (canceled)

5. The method according to claim 2, wherein said first polymer film is applied on said first side of said dry MFC film in melt form by extrusion coating.

6. The method according to claim 2, wherein said first polymer film is applied on said first side of said dry MFC film as a solid film.

7. The method according to claim 6, wherein at least one surface of said solid first polymer film is a metallized surface.

8. (canceled)

9. The method according to claim 2, wherein said first polymer film is a foamed film.

10. The method according to claim 1, wherein a second polymer film is applied on a second side of said MFC film after said barrier substrate is separated from said non-porous support, wherein said second side of said MFC film is opposite said first side of said MFC film.

11. The method according to claim 10, wherein said second polymer film comprises a thermoplastic polymer.

12-13. (canceled)

14. The method according to claim 11, wherein said second polymer film is applied on said second side of said dry MFC film in melt form by extrusion coating.

15. The method according to claim 11, wherein said second polymer film is applied on said second side of said dry MFC film as a solid film.

16. (canceled)

17. The method according to claim 15, wherein at least one surface of said solid second polymer film is a metallized surface, and
wherein the metallized surface of said solid second polymer film is formed by vapor deposition of a metal or metal oxide on the solid second polymer film.

18. The method according to claim 11, wherein said second polymer film is a foamed film.

19. The method according to claim 1, wherein said MFC suspension comprises between 70 weight-% to 100 weight-% of MFC based on the total dry weight.

20. The method according to claim 1, wherein said dry MFC film has a grammage of 2-70 g/m².

21. The method according to claim 1, wherein each nip of said at least one nip is selected from a group consisting of: a lamination nip, a calender nip, a smoothing roll nip, a press nip, a belt nip, and an extended nip.

22-24. (canceled)

25. A method for producing a laminate, wherein said method comprises the steps of:
providing a paper or paperboard substrate,
providing a barrier substrate according to the method of claim 1, and
joining a first surface of said paper or paperboard substrate with said MFC film of said barrier substrate using at least one tie layer to obtain the laminate.

26. The method according to claim 25, wherein said method further comprises a step of:
providing said laminate with an outermost polymer layer on one side or on both sides.

27. A barrier substrate comprising an MFC film and a first polymer film, obtained by the method as claimed in claim 1.

28. A laminate obtained by the method as claimed in claim 25.

29. A packaging material comprising the laminate according to claim 28.

30. (canceled)
